(19) United States
(12) Patent Application Publication
(10) Pub. No.: US 2020/0061787 A1
(43) Pub. Date: Feb. 27, 2020

(54) Fastening tool

(71) Applicant: Patrick Hale, Hamilton (CA)

(72) Inventor: Patrick Hale, Hamilton (CA)

(21) Appl. No.: 16/673,189

(22) Filed: Nov. 4, 2019

Related U.S. Application Data
(63) Continuation-in-part of application No. 15/353,728, filed on Nov. 16, 2016, now Pat. No. 10,464,196.
Application No. 15/353,728 is a continuation-in-part of application No. 13/650,436, filed on Oct. 12, 2012, now abandoned.

(51) Int. Cl. B25C 1/04; B25C 1/02

(52) U.S. Cl. CPC B25C 1/047; B25C 1/02

(57) ABSTRACT

A fastening tool has a tool body. A passage has a lower straight section at one orientation, an upper straight section at a different orientation and an interconnecting curvilinear passage section. A fastener driver sliding in the passage has a lower fastener impact segment, an intermediate a flexible driver segment, and an upper hammer segment. The flexible driver segment is constrained by an inside surface of the curvilinear passage section for curvilinear sliding. A leading part of the flexible driver segment and the impact segment are constrained by an inside surface of the lower linear passage section for linear sliding.

### CROSS REFERENCE TO RELATED PATENTS

The present application is a continuation-in-part of, and claims priority from, pending U.S. patent application Ser. No. 15/353,728 filed Nov. 16, 2016, entitled “Fastening tool and method of operation”. U.S. patent application Ser. No. 15/353,728 is a continuation-in-part of, and claims priority from, U.S. patent application Ser. No. 13/650,436 filed Oct. 12, 2012, now abandoned, entitled “Fastening tool and method of operation”. The contents of the above applications are incorporated herein by reference and in their entirety for all purposes.

### FIELD OF THE INVENTION

This invention relates to a fastening tool and has particular but not exclusive application for fastening floorboards to a subfloor where the board has to be fixed very close to a wall.

### DESCRIPTION OF RELATED ART

Floorboards are generally milled as lengths of several feet and widths of a few inches. Typically the boards are from a half to one inch in thickness with one edge formed with a tongue and the other edge formed with a matching groove. The boards are laid edge to edge with the tongue of one board inserted into the groove of the next adjacent board. The boards are laid successively from one wall of the room. For a neat appearance and to avoid the presence of grooves between adjacent boards where detritus can gather, a board being nailed is pressed tightly against the previously laid board before it is fastened.

Generally boards are fastened using nails or staples so that the fastener is not visible in the finished floor. One way of doing this is to drive the fastener diagonally into the side of the board so that the fastener penetrates the edge of the board at an entry position spaced from the board top face. The fastener is driven through a lower part of the board, exits the bottom face of the board and enters the subfloor. The fastener is driven some way into the subfloor and the frictional grip between the leading part of the nail or staple and the subfloor material such as plywood retains the fastened board in position against the subfloor and against its neighboring board. The boards are laid in sequence so that the grooved edges face the starting wall and fasteners are driven through the tongued edges. The fastener is driven into the tongued edge at 45 degrees to the vertical at the corner junction between the top edge portion of the board and the top face of the tongue. In this way, the fastener does not protrude in such a way as might adversely affect the fitting of the next board to be fastened against the board previously fastened. The successive fastening in this way means that an essentially integral floor structure is obtained with each fastening of a board contributing through the tightly interlocking of the tongue and groove arrangement to the clamping in place of its neighboring boards.

The angled drive applied to a fastener has two mechanical effects. Firstly, the horizontal component of the applied angled drive presses a board to be fastened laterally against the previously laid board so that the respective tongue and groove are locked and the adjacent edges of the two boards are pressed tightly together. Secondly, the vertical component of the applied angled drive presses the board being fastened firmly against the subfloor so that there is no gap between the board and the subfloor after the fastening operation is complete. The two mechanical effects overlap during the driving operation so that the lateral pressure is applied to the board as it is fixed to the subfloor.

A conventional fastening tool has a cartridge of fasteners such as staples or nails, a multiple charge of fasteners being spring mounted in the cartridge so as to bias a leading fastener into a position ready for its being driven. The tool has a rebated shoe which is used to locate the tool next to a board in the proper position for executing a fastening operation. The rebate is dimensioned so that its top face sits on top of the board to be fastened, its vertical face fits against the tongued end of that board, and an adjacent heel section of the shoe rests on the subfloor. The shoe has a launch aperture through which the readied fastener is driven in an operation as previously described. Once the fastener is driven into the board, the next adjacent fastener in the cartridge is spring biased into the ready position and the tool is lifted away from the board and located against another section of the board edge in preparation for driving another fastener.

In order that the fastener is effectively driven through the board and into the subfloor, a drive must be applied longitudinally to the fastener; i.e. along the line of the shank in the case of a nail and along the line of the two penetrating spikes in the case of the staple which is generally of the form of an inverted U. The drive applied is a percussive drive rather than the application of a high, non-percussive force. This, in turn, means that a hammer element such as a hammer head or a piston must gain momentum before it strikes the readied fastener to drive it through an edge portion of a board and into the subfloor. In a mechanical version of the flooring tool, a piston is spring mounted for reciprocation in a tool barrel. The piston has a leading edge adapted to strike the readied fastener and a strike head at the other end of the piston which is hammered to effect piston movement against the spring mounting to drive the leading edge against the fastener. In the case where such a tool uses an adjunct power source, there is usually a two-phase drive. Typically, such an adjunct power source is compressed air, although power sources, such as electromagnetism, flammable expanding gases (e.g. propane), or a small explosive charge may alternatively be used. It is understood that although compressed air is the favored and effectively the most used fluid for fastener driving tools, other suitable compressible fluids or other power adjuncts could be used without departing from the scope of the present invention. For a compressed air powered driving tool, a top piston is first hammered against a spring bias to initiate drive of the top piston along a barrel. At a certain distance along its travel, the top piston clears an aperture in a wall of the barrel allowing fluid communication with a source of compressed air. Compressed air is then injected into the barrel to force a bottom piston against the readied fastener.

One issue with known board fastening tools is that a finite travel of the piston (or pistons in the case of the compressed air tool) in the barrel is needed to generate the required momentum for the fastener to be driven into the board and subfloor from its readied position. In addition, a swing of the hammer is required that further lengthens the drive room needed. Because swinging the hammer and driving the piston along the inclined barrel occur in the direction that the boards are being laid—i.e. away from the starting wall—this means that as illustrated by FIG. 1, the driving tool cannot be used to fasten the last few boards before the finishing wall. The number of rows is dependent on the width of the boards. Typically, for 3 inch boards, operation on the last four rows is prevented; for 4.5 inch boards, operation on the last 3 rows is prevented, etc. To finish the installation a different nail gun, known as a “brad-nailer”, is used, this tool using a smaller gauge nail; 1-2″ in comparison with a 2″ staple conventionally used by the board fastening tool. Such nailers are less effective for fastening floorboards as they do not provide the desired angular drive to a fastener.

### SUMMARY OF THE INVENTION

According to an aspect of the invention, there is provided a fastening tool comprising a tool body having a passage therein, the passage having a curvilinear passage section and a first linear passage section having a first linear direction, the curvilinear passage section contiguous at a leading end thereof with a trailing end of the first linear passage section, an elongate driver mounted in and slidable along the passage, the driver having a linear impact segment and a flexible driver segment, the impact segment having a leading end for driving a fastener and a trailing end fixed to a leading end of the flexible driver segment, the flexible driver segment constrained by an inside surface of the curvilinear passage section for curvilinear sliding therealong, the linear impact segment and a leading part of the flexible driver segment constrained by an inside surface of the first linear passage section for linear sliding therealong.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a side view of a prior art fastening tool.

FIG. 2 is a side view of a fastening tool embodying the invention.

FIGS. 3 to 5 are vertical section views through a body section of the tool of FIG. 2 showing stages in the use of an adjunct power source to drive fasteners.

FIG. 6 is a perspective view showing a shoe forming part of a fastening tool, the shoe shown in juxtaposition to floorboards being fastened to a subfloor.

FIG. 7 is a vertical sectional view through a lower section of the tool of FIG. 2 showing the tool in a strike (or “fastener ready”) condition.

FIG. 8 is a vertical sectional view corresponding to the view of FIG. 7, but showing the tool following completion of a fastening operation.

FIG. 9 shows a front elevation of a driver for use in a fastening tool according to an embodiment of the invention.

FIG. 10 is a vertical sectional view of the driver of FIG. 9.

FIG. 11 shows the driver of FIG. 9 in side elevation showing the driver in deployed condition.

FIG. 12A is a front view of one form of driver assembly according to an embodiment of the invention.

FIG. 12B is a back view of the driver assembly of FIG. 12A.

FIG. 13 is a sectional view of the driver assembly of FIG. 12A.

FIG. 14 is a front elevation of an alternative design of driver assembly according to an embodiment of the invention.

FIG. 15 is a side elevation of the driver assembly of FIG. 14.

FIG. 16 is a sectional view through a flexible section of the driver assembly of FIG. 14.

FIG. 17 is an end view of the driver of FIG. 14 at the fastener driving end.

FIG. 18 is a vertical sectional view of an alternative form of flexible driver, the driver shown in an unloaded condition.

FIG. 19 is a side elevation of the driver of FIG. 18, the driver shown in a loaded condition.

FIG. 20 is a vertical sectional view through part of a lower section of a tool according to another embodiment of the invention.

FIGS. 21A, 21B and 21C shows a side section, a section on the line B-B and a section on the line C-C, all of a leading end of a driver and an accommodating passage according to an embodiment of the invention.

FIGS. 22A, 22B and 22C shows a side section, a section on the line B-B and a section on the line C-C, all of a leading end of a driver and an accommodating passage according to another embodiment of the invention.

FIGS. 23A, 23B and 23C shows a side section, a section on the line B-B and a section on the line C-C, all of a leading end of a driver and an accommodating passage according to a further embodiment of the invention.

FIGS. 24A, 24B and 24C shows a side section, a section on the line B-B and a section on the line C-C, all of a leading end of a driver and an accommodating passage according to yet another embodiment of the invention.

### DETAILED DESCRIPTION OF THE INVENTION INCLUDING THE PRESENTLY PREFERRED EMBODIMENTS

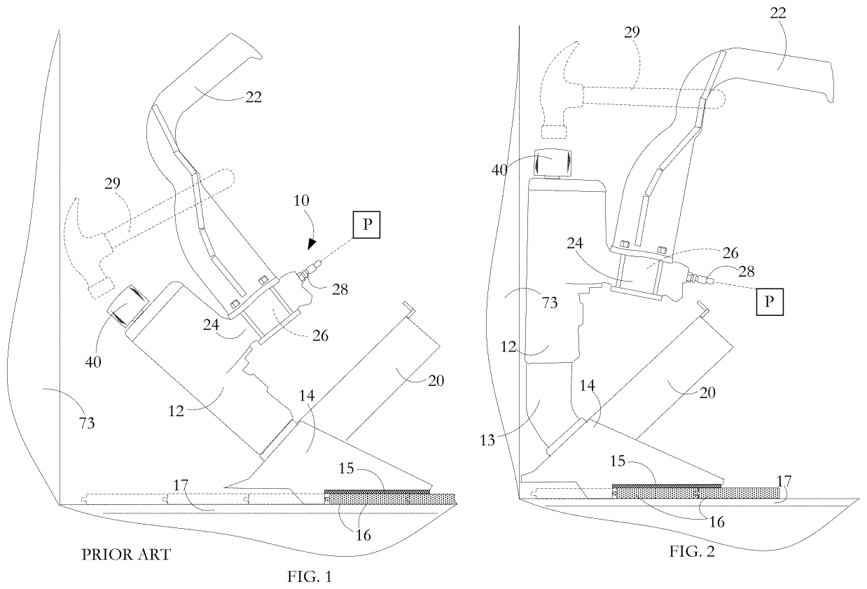

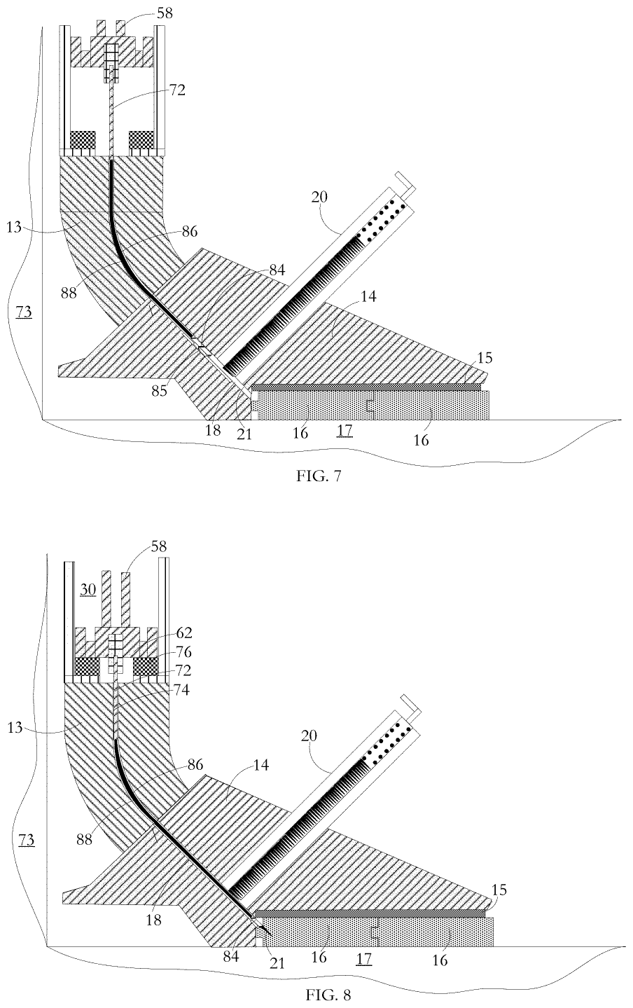

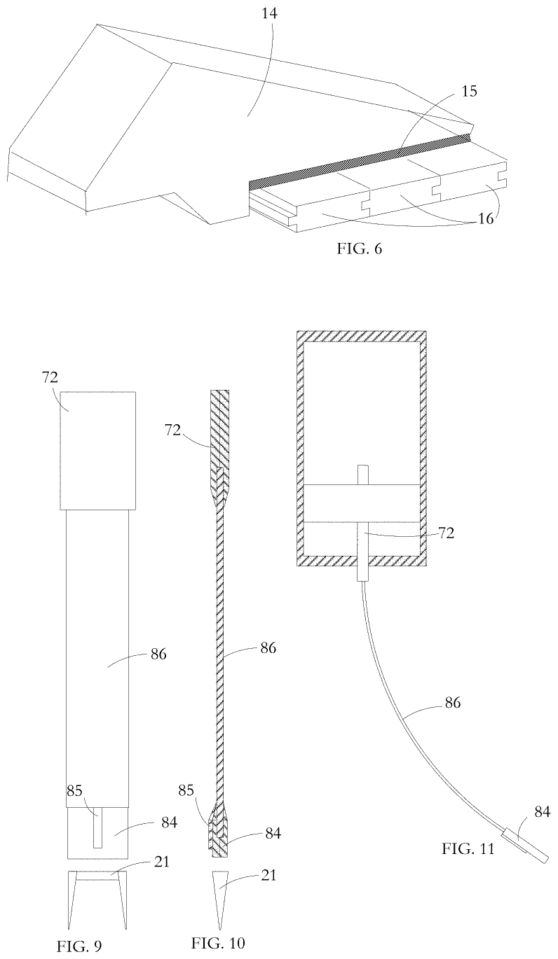

FIGS. 1 and 2 show pneumatic fastening tools 10, each having a hollow generally barrel-form body 12. A shoe 14 for engaging a tongue and grooved floorboard 16 to be fastened to a subfloor 17 is mounted at a lower end of the body 12. The shoe 14 includes a passage for receiving a leading fastener from a spring-loaded series of fasteners fed from a magazine or cartridge 20. The fasteners are conventionally either nails or staples although other forms of fastener are possible for other fastening purposes. In use, the passage guides the lead fastener from a strike position into the tongued end of a floorboard 16 to be fastened with the floorboard located under the shoe 14 as shown in FIG. 6 as the lead fastener is driven out of the driving tool 10. Because any of a range of thicknesses of board may be used, a spacer 15 is attached to an underside rebated part of the shoe 14 so as to adapt the rebate height to the thickness of boards 16 to be fastened to the subfloor 17. The fastener driving tool 10 has a handle 22 mounted to a spur member 24 projecting from the body and integral with it. The spur member 24 has an inner chamber 26 for containing a charge of compressed air, the member having a connector 28 in its wall for connection to a source P of compressed air. Driving of a fastener into the edge of a board and into the subfloor is initiated by swinging a hammer 29 and striking a cap covered anvil 40. The tool of FIG. 1 is known prior art. The tool of FIG. 2 tool has a coupling section 13 linking the barrel body 12 and an upper part of the shoe 14 and embodies principles of the present invention.

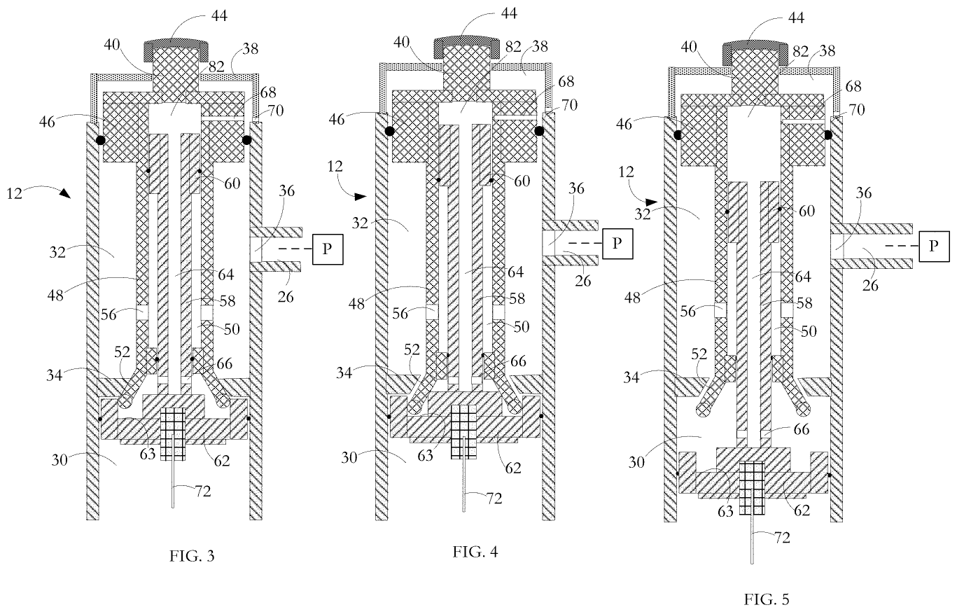

Shown in sectional view in FIGS. 3 to 5 is an arrangement of elements for the tool of FIG. 2, the elements functioning to provide compressed air from a power source P for converting a blow from the hammer 29 applied to the anvil 40 to an impulsive or percussive force of desired power and speed at a readied fastener. The body 12 has lower and upper chambers, respectively, 30 and 32. An annular seat 34 integrally formed with the body inner wall separates the chambers 30 and 32. An opening 36 permits continuous air exchange between the chambers 26 and 32. The body 12 is fitted at its upper end with a cover 38 from which protrudes a slidable anvil member 40 through a top opening 42, the anvil member 40 being covered with a soft cap 44. Anvil member 40 is attached at its lower end to an annular actuator 46 which seals against the interior of chamber 32 and is axially slidable along it. The actuator 46 sealingly engages the outer surface of a hollow cylindrical poppet valve 48 which has an inner channel 50. A lower end of the poppet valve 48 is formed with a conical valve head 52 which is operable to engage with and disengage from a face of the complementarily shaped annular seat 34. Poppet valve member 48 has several radial bores 56 located near valve head 52. A hollow piston 58 is axially slidable inside the channel 50, the piston 58 being guided by means of a sleeve 60 which slidably and sealingly engages the inner wall of poppet valve member 48 at an upper end of the piston. The piston 58 is guided at its lower end by a disc 62 attached to the piston 58 which slidingly and sealingly engages the main body 12 inner wall, the disc 62 having a dish form upper surface 63. A bore 64 extends longitudinally through the centre of the piston 58, the bore providing fluid communication via vent passages 66 between a portion of the upper chamber 32 located above actuator 46 and the portion of lower chamber 30 located above slider disc 62. Exhaust holes 68 are located between the lower end of anvil 40 and the upper end of actuator 46, the holes being in registration with corresponding exhaust holes 70 in cover 38.

A fastener driver has a hammer section 72 attached to the lower end of piston 58 and is vertically drivable along a straight vertical section 74 in shoe 14 (FIGS. 7 and 8), the section 74 forming part of a passage in which the fastener driver slides. A pad 76 is located at the bottom end portion of lower chamber 30, to receive and absorb the impact of the downwardly propelled disc 62. The lower and upper chambers 30, 32 are lined to enable smooth sliding engagement of disc 62 in lower chamber 30 and of actuator 46 in upper chamber 32. The anvil 40 encloses a chamber 82 which acts as a shock absorber to dampen upward movement of piston 58 when the piston is biased upwardly after a fastener has been driven by the action of the compressed air on the sleeve 60. Once the upper ends of sleeve 60 and piston 58 move into chamber 82, the air trapped in the chamber acts as a dampening cushion to reduce the impact during use of the piston slider disc 62 against lower seat 34.

Referring to FIGS. 7 and 8, the driver has three contiguous sections: a generally vertically disposed hammer section 72, a short impact section 84, and a flexible section 86 of spring steel extending between the hammer section 72 and the impact section 84. The hammer section 72 is mounted centrally of the piston 58 and has a lower part received in a vertical passage section 74 formed in the coupling section 13. The hammer section 72 is driven vertically up and down with the movement of the piston 58 previously described with reference to FIGS. 3 to 5. The impact section 84 is mounted for reciprocal linear movement within the inclined linear passage section 18 in shoe 14. A lead fastener 21 from the fasteners stored in the magazine 20 is automatically biased to a ready or strike position in passage section 18 as shown in FIG. 7. The flexible section 86 is reciprocally moveable within a curvilinear passage section 88 in the coupling section 13, the passage section 88 extending between and contiguous with the passage sections 18 and 74. The flexible section 86 transforms the vertical reciprocation of the hammer member 72 into reciprocation of the impact section 84 within the passage section 18. In a fastener-ready, pre-impact position as shown in FIG. 7, the flexible section 86 is positioned so that an upper part is in the top straight passage section 74 and a lower part is in the curvilinear passage section 88. In a fastener-driven or post-impact position as shown in FIG. 8, an upper part of the flexible section 86 is in the curved passage section 88 and a lower part of the flexible section 86 is in the linear passage section 18.

The hammer section 72 and the impact section 84 are made of hardened steel and the flexible section 86 is made of spring steel. Examples of suitable spring steel are as follows, the chrome-silicon spring steel being especially valuable for its fatigue resistance.

| | SAE | | Yield | |
|---|---|---|---|---|
| Material | grade | Composition | strength | Hardness |
| Blue | 1095 | 0.9-1.03% carbon, | 413-517 | Up to 59 |
| spring | | 0.3-0.5% manganese, up to | megapascals | HRC |
| steel | | 0.04% phosphorus, and | | |
| | | up to 0.05% silicon | | |
| Chrome- | 5160 | 0.55-0.65% carbon, | 669 | Up to 63 |
| silicon | | 0.75-1.00% manganese, | megapascals | HRC |
| spring | | 0.7-0.9% Chromium | | |
| steel | | | | |

In one embodiment, the flexible section 86 is of the order of 0.25 inches in thickness and a half inch in width. It is welded at one end to the rigid hammer section 72 and at the other to the impact section 84. The impact section 84 cannot be too long otherwise it will either enter and jam in the curved passage section 88 when the driver is retracted to the pre-strike position or it will mean an the tool having a larger length which would reduce the tool utility. The impact section 84 must however be long enough to provide a linear plane to assist in alignment when firing. If it is too short, the sliding linear plane is not developed meaning that the impact section could steer off alignment and misfire. As shown in the embodiment of FIGS. 9 to 11, the flexible section 86 is welded at its respective ends between rabbeted flanking plates at the hammer section 72 and the impact section 84. In one example, an end part of the flexible section 86 is reduced to a thickness of 0.125 inches and is welded at 0.065 inch rabbets 106 in each of the flanking plates of the hammer section 72.

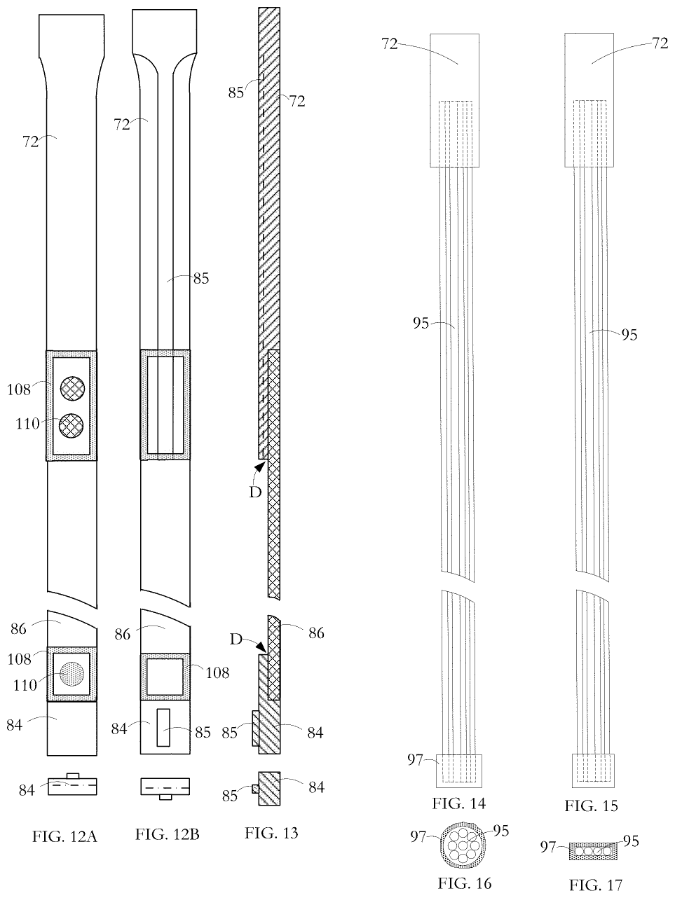

As shown in the alternative embodiment of FIGS. 12A, 12B and 13, the spring steel flexible section ends are welded at rabbets 106 formed at respective faces of the hammer section 72 and the impact section 84. In one example of this structure, the ends of the flexible section 86 are again reduced to 0.125 inches in thickness and welded at a 0.125 inch deep single rabbet 106. The rabbets 106 are excavated using a computer numerical control (CNC) grinding process adapted for grinding hardened steel.

In one fixing method for making the combined driver, TIG (Tungsten Inert Gas) welding, also known as GTAW (Gas Tungsten Arc Welding), is used to fasten respective ends of the spring steel segment 86 (or ribbons 92, 94) to the hammer segment 72 and to the impact segment 84. TIG welding can be configured to produce a malleable and tough weld in comparison to a hard but brittle weld obtained using many other welding processes. That is particularly important for the impact segment weld. TIG welding uses a non-consumable electrode and a shielding gas to make and protect the joint during the welding process. In one embodiment, the spring steel segment 86 is welded only along the periphery 108 of the joint between the end of segment 86 and the impact segment 84 and, similarly with the joint between the other end of segment 86 and the hammer segment 72. In an alternative embodiment, regions 110 on the hammer segment 72 and the impact segment 84 are machined and then welded to the flexible segment 86 as shown in FIGS. 12A, 12B and 13. In a further alternative, the weld area spans the whole of the overlap between the spring flexible segment 86 and the impact segment 84. A greater weld area contributes to overall strength although the length and therefore the overall permitted weld area is somewhat limited owing to the impact segment's small length. Care is needed in the applied weld conditions particularly in pre-heat and post-heat welding phases in order to avoid residual stresses which would otherwise lead to accelerated failure. In a pre-heat phase, weld current is set at from 20-30% of the primary weld current and cycles for 40 to 60% of the weld time. In a post-heat phase, the weld current is set at from 5-25% of the primary weld current and runs for 40-80% of the weld time.

In use, the impact segment 84 slides along the straight inclined passage section 18 while being maintained in linear alignment with the passage section 18 in order to achieve effective alignment of an end tip of the impact segment 84 with a fastener to be driven. In one embodiment, the alignment is obtained by having walls of the passage section 18 in close but non-binding proximity to outer walls of the impact segment 84. For example, for use with a staple fastener, the end tip of the impact segment 84 is rectangular with a cross-sectional area substantially the same as the backbone of the staple, while for a round headed nail, the passage section 18 and the tip of impact segment 84 are cylindrical.

The impact segment tip thickness and width is such that the tip strikes only the leading fastener in the magazine 20. Once the fastener has been driven and the driver returns to the strike position, the next fastener is pushed into a ready position via a spring in the magazine assembly. For effective driving of a single fastener, anything immediately ‘behind’ the impact segment tip—that is, the weld length and a front part of the flexible segment—must not protrude beyond the tip cross-sectional profile otherwise there is a risk of binding in the passage section 18 and/or the projecting part colliding with a the edge of the stored fastener which is immediately adjacent the target fastener.

With reference to FIGS. 23A to 23C, in an alternative embodiment of the invention, to aid in maintaining linear sliding of the impact segment 84 along the inclined passage section 18, the impact segment 84 has a linear tracking projection 85 received in and slidable along a linear groove 87 formed in a side wall of the passage section 18. Notwithstanding the presence of tracking projections 85 and grooves 87, part of the inside surface of passage section 18 defines a passage core 91, and the impact segment 84 and the weld zone or fixing length 89 have an outside surface defining a driver core 93, the relative core dimensions enabling closely confined, non-binding linear sliding of the driver core 93 along the passage core 91. In this embodiment, the end tip of the driver core is dimensioned substantially to match the head of the fastener (now shown)—in this case, a circular fastener.

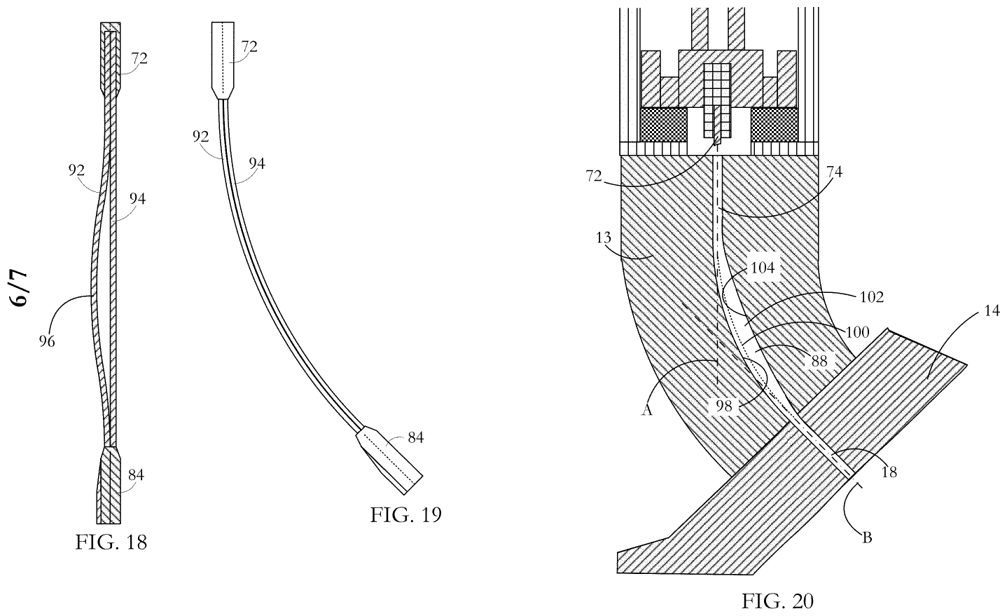

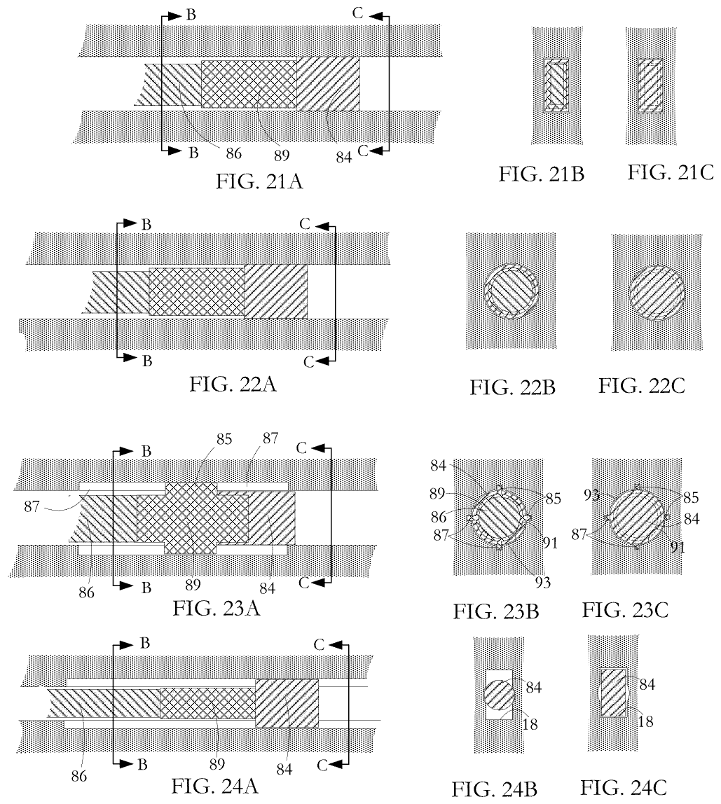

As shown in FIGS. 21A to 21C (rectangular cross-section impact segment 84) and FIGS. 22A to 22C (circular cross-section impact segment 84), the cross-sectional extents of the leading end part of the multi-segment driver, including fixture or weld length 89 and a leading part of the flexible segment 86, are made no greater than the cross-sectional extent of the tip of the impact segment 84. If fixing of the flexible segment 86 to the impact segment 84 is by means of welding at an overlap 89 between them, and if the initially created weld is too thick, it is ground down to ensure it is co-planar or otherwise has surface co-extensivity with the impact segment 84. Dimensions are set such that, in operation as the driver moves along the passage, the leading part of the flexible segment 86 and the welded or fixing region 89 ‘hide’ behind the impact segment 84.

The impact segment 84 cannot be made too long because, upon retraction, it would begin to enter the curvilinear passage section and because it cannot bend, it will bind. The impact segment 84 sits just above a readied staple in the fully retracted, pre-impact position and only travels down the linear passage section 18 shown in FIG. 8. In one example, the impact segment is ⅛″ thick, of which, in this embodiment, the lower half consists of the tracking part 85 and the upper half is the impact part 84. The impact segment tip is 0.25 inches long and rabbet length is 0.25 inches. The rabbet is formed by grinding the blade tip down to a thickness of about 1/64″ layer enabling the flex steel ribbon or ribbons to be welded on top. If the base is too thick, the driver does not slide in the passage section 18. If too thin, the weld area is too weak and fails on impact. The positions D are critical points because it is here that any bending of the spring steel flexible ribbon(s) is necessarily halted. However, the flexible driver segment has a length that is longer that the combined length of the arced passage section and the driver transit travel from pre-impact to completed fastening. This means that at positions D, there is neither a bending moment transmitted from the curved part of the ribbon(s) nor any concomitant stress localization.

In use, the fastener driving tool 10 is initially in a resting position as shown in FIG. 3. In this position, within the barrel 12 of the tool, atmospheric pressure exists in the annular area above the actuator 46 and exists also both in the area of lower chamber 30 between the poppet valve head 74 and the disc 62 and in the lower chamber 30 under slider disc 62. Compressed air is continuously fed into reservoir 26 through connector 28 and so chamber 32, which is in continuous communication with air reservoir 26, is also filled with compressed air. Because the lower face of the actuator 46 has a greater surface area than the upper conical face of valve member head 52, the overall pressure differential on the poppet valve 48 upwardly biases the poppet valve member 70 to an upper limit position to sealingly engaging the valve head against seat 34. Compressed air is also allowed through bores 56 into poppet channel 50 under sleeve 60, to upwardly bias the sleeve 90 and its associated piston 58 to an upper limit position.

When a hammer blow is applied to anvil 40, actuator 48 is driven downwardly in chamber 32 as shown in FIG. 4. Provided the hammer blow has a force sufficient to counteract the pressure differential resulting from the surface area differential between the actuator 46 and the valve member 52, the actuator 46 and poppet member 48 engaged by it are moved downwardly as shown in FIG. 4. Once the valve member 52 is at a lowered position, compressed air can flow around it into lower chamber 30 above disc 62. Since atmospheric pressure exists under disc 62, the latter is suddenly downwardly driven by the incoming compressed air to downwardly drive the hammer segment 72 as shown in FIG. 5. Since the surface area of upwardly facing disc 62 is greater than the surface area of downwardly facing sleeve 60, the resistance exerted by the sleeve 60 to the downward movement of piston 58 is insignificant. Once piston 58 hits annular pad 76, it reaches its lowermost position.

As shown by FIGS. 7 and 8, the downward movement of hammer segment 72 is transmitted to the flexible segment 86 and the impact segment 84. The flexible segment 86 is forced into a curved configuration as it slides against a back wall of the curvilinear passage section 88. Both the flexible segment 86 and the back wall are burnished to minimize friction between them. Sliding of the flexible segment 86 in the curved passage section 88 is also facilitated by the application of lubricant. The spring steel segment 86 is prevented from moving laterally by the mounting of the hammer segment 72 in the piston 58 at the upper end of the flexible segment and by the reciprocation of the piston 58 in the barrel body 12. The passage section 18 has a groove in its back wall which receives a projecting rib 85 on the impact segment 84 as illustrated in FIGS. 9 to 11 to ensure good tracking. As shown in FIGS. 9 and 10, the impact segment tip 84 is matched to the head shape of the fastener 21. I.e., it is a blade edge for use in driving a staple and is a circular punch-like tip for driving a nail. In one example, for a 135 degree angle between the vertical percussion direction and the fastener device drive direction, the curved passage section 88 has a radius of curvature of the order of 1.8 inches.

It can be seen that the vertical reciprocation of the hammer segment 72 results in the tip of impact segment 84 driving a staple fastener 21 diagonally into the floorboard 16 as shown in FIG. 8. Moreover, compared with the prior art as illustrated in FIG. 1, it will be apparent that the driving tool 10 can be used to fasten boards 16 that are closer to the “finishing” wall 73 than is possible with the design shown in FIG. 1.

The blow to anvil 40 only temporarily shifts the pressure balance in the tool main body 12. The pressure balance quickly returns to its initial condition after the hammer blow has been effected and the lead fastener has been driven into a floorboard 16. At this point, poppet valve 48 returns to its resting position owing to the greater pressure applied by the compressed air on the bottom of the actuator 46 than on the top of the poppet valve 48. The poppet valve member 48 sealingly engages the seat 34 once again under the bias of the upwardly moving actuator 46. The compressed air in the chamber 30 above disc 62 flows through holes 66 into piston channel 64, through poppet channel 50 (above sleeve 60) and out of tool 10 through exhaust holes 68 and 70. Once the pressure in lower chamber 30 above disc 62 nears atmospheric pressure, the upward pressure applied by the compressed air against sleeve 60 drives piston 58 upwardly in poppet channel 50 back to its initial upper limit position as shown in FIG. 3. The upward movement of piston 58 is dampened when it nears its upper limit position, by the presence of an air cushion at atmospheric pressure in dampening chamber 82.

The fastening tool has some tendency to lift slightly from the flooring when a fastener is expelled due to the exiting fastener hitting the hard floor, which may result in the fastener not being properly driven into the board and subfloor. Because the hammer blow applied to the anvil 40 is substantially vertically directed, this helps to limit this upward reaction.

The function of the flexible spring steel segment 86 housed within the curved passage section 88 is to convert the downward motion of the anvil to the diagonal motion of the tip of impact segment 84. The cross-sectional shape of the spring steel segment 86 can be other than the rectangular form illustrated. For example, the ribbon cross-section may be arcuate, square, circular, lobed, etc., and such alternative cross-sectional shapes and appropriately cross-sectioned curved passages are intended to be recognized as encompassed in this specification by the use of the term “ribbon”. Such flexible segments can have a lower end part that is finished with a shape smaller than and/or or even different from, the cross-section of the main part of the ribbon so as to enable effective welding between the spring steel segment 86 and the impact segment 84.

In a further embodiment, FIGS. 18 and 19 show a different form of spring steel device 92, 94 extending between the driver member 72 and the blade 84. As in the embodiment illustrated in FIGS. 7 and 8, the spring steel device 92, 94 is reciprocally moveable within the curved passage section 88 in the tool body coupling section 13, the curved passage section contiguous with the passage sections 18 and 74. The flexible segment in this case consists of a pair of spring steel ribbons 92, 94 that are joined to each other at respective ends, but which are separate from each other over an intermediate region 96. The ends of the spring steel ribbons are welded or otherwise fixed to the hammer segment 72 at one end and to the impact segment 84 at the other. In one example, the ends of each ribbon 92, 94 are reduced to about 0.07 inches in thickness and welded into a corresponding accommodating rabbet or rabbets in one or both of the flanking plates. As shown in FIG. 18, which shows the driver in an unloaded condition, the flexible ribbon 92 is longer than the ribbon 94. The two ribbon lengths are set in dependence on the bottom outer surface arc 98 (FIG. 20) and mid-plane arc 100 of the passage section 88. In use, when the flexible segment is loaded, i.e. during the process of driving a staple or nail, the outer and inner ribbons 92, 94 come together over the intermediate region 96 as shown in FIG. 19.

The double ribbon structure is adopted to minimize fatigue stresses on the flexible segment. If a single thick flexible segment is used, the half of the ribbon at the inside curve is in compression as it is driven into and along the curved passage section, the compression being particularly high at the inner surface. Similarly, the other half of the ribbon at the outside curve is in high tension particularly at the ribbon outer surface. With each drive of a nail/staple the driver is significantly stressed as it is driven into and through the curved path, the stress then being released when the drive is retracted. This cycle causes fatigue wear which, in turn, increases the risk of work hardening of the ribbon causing a gradual loss of flexibility and eventually breakage. In comparison, the ribbons used in the FIG. 18-20 embodiment are subjected to reduced stress across each ribbon 92, 94 leading to a longer driver life. While two ribbons are satisfactory for most practical applications, three or more ribbons of appropriate length can be joined at their respective ends with the resulting device being used as previously described, such an embodiment being valuable for heavy duty operation and for tight curvature implementations. Generally, multiple ribbons improve resistance to fatigue. Ribbons of different length, when welded to the hammer and impact segments induce a minor curve in the overall assembly. This reduces the stress on the driver as it moves along the curved passage section. The arc length (c) of the track is c=2πr. On the top side (inside of arc) of the track the radius is smaller than on the bottom side (outside of arc). With multiple, thin, flex steel ribbons, the length of each ribbon can vary depending on the particular arc length that they are being positioned (shorter on the top side radius and longer as they are positioned nearer the bottom side). This way, the driver naturally creates the arced shape with minimal bending on each individual ribbon. If only one ribbon is used, the top portion on the individual ribbon is under compressive stress and the bottom side is under tension to bend into the arced track and during the firing of the fastener. This greater stress and of opposite magnitude (tension and compression) accelerate fatigue wear. On the other hand, using one flex steel ribbon is easier in terms of assembly.

In an alternative embodiment, the flexible driver segment 88 is in the form of multiple elements which do not lie flat against one another. One exemplary structure is so-called aircraft cable 95. As shown in FIGS. 14 and 16, the multi-part flexible cable is nominally circular in cross-section and has a capped end 97. In use, a flexible section of the cable 95 is housed within and moves along a circular cross-section curvilinear passage section 88 that closely accommodates the cable 95 while permitting it to slide relatively freely backwards and forwards along an outer wall of the passage section 88. The length of the capped end 97 is made long enough to develop a linear plane but short enough that it does not enter and bind in the arc passage section 88 when the driver is in the retracted position. The capped end 97 can be circular to match the head end of a circular fastener. Alternatively, the capped end graduates from the circular profile of the aircraft cable to a rectangular profile for driving staples. In this case, the end cap 97, including any associated weld or fixture zone 89, is made sufficiently long that only a matching rectangular profile slides in the straight track section 18. Alternatively, the passage section 18 is modified to accommodate a round to rectangular transition. In a further alternative as shown in FIGS. 15 and 17, the cable is a flat cable and the capped end 97 matches the backbone of a staple.

To reduce stress and strain on a spring steel device and as shown in FIG. 20, the passage section 88 can be made wider over a center region 102 than at the ends where it joins the linear passage sections 74 and 18. The outer surface arc 98 is tangent to the vertical driving motion as shown at A and is tangent to the fastener drive direction as shown at B so that the required driving action and orientations are maintained. While the radius of curvature selected can vary depending on the geometry of the coupling body 13, the outer surface arc 98 is selected to be tangent to the two critical directions of motion: the hammer segment direction and the impact segment direction. The value of the variable width curved track section is realized in the driver retraction process. When a double element ribbon of the sort shown FIG. 18 is driven through the arc in a loaded condition, it resembles one member as shown in FIG. 19, with the inner ribbon 94 flexing towards the outer ribbon 92 and the latter travelling along the outer surface arc 98. When the flexible driver begins to retract after the fastener has been driven home, the spring steel device 92, 94 is unloaded and it seeks to adopt more the form of FIG. 18. With the larger radius of curvature of the inner surface arc 104 of the curved passage section 88, the relaxed inner ribbon 94 can pass through the relieved centre of the curved passage section 88 with less force applied from it to the track inner curved surface which would otherwise cause higher frictional and mechanical stress. Again, this reduces fatigue damage and increases device lifetime. In one example, for a 135 degree difference between the vertical percussion direction and the fastener device direction, an outer surface radius of 1.81 inches and an inner surface radius of 3.5 inches were adopted over respective center regions of the curved track. While it is preferred that the inner surface is curved, it does not have to have a fixed radius of curvature provided that it provides the required relief. A corresponding stress relief is achieved by the relieved track with a single element ribbon or multiple (more than two element) spring steel ribbon.

In each of the embodiments described and illustrated, the passage section 74 extends generally vertically. The upper part of the tool can alternatively be configured so that the passage section 74 is off-vertical: i.e. the top of the passage section 74 inclines slightly towards the wall (when in use) or even inclines slightly away from the wall.

It will be appreciated that in each of the foregoing embodiments, the impact segment 84 is driven by the spring steel driver segment 86 to eject the readied fastener out of the fastening tool and into the floorboard to be fastened generally at the corner between the bottom edge of the board and the upwardly orientated face of the tongue. The force applied to the fastener is diagonally directed and so one component of this acts to drive the board being fastened against the previously laid board to squeeze the two boards together at the moment of impact.

While the specific embodiments described above relate to a board fastening tool for fastening a floor board to an underlying structure such as a subfloor, it will be appreciated that the principles of the invention can be used on other fastening tools such as trim guns and framing guns where space in relation to a “finishing” wall or other limiting surface or object means that the actuating room for the tool is limited. Tools of a range of sizes, both manually operated and power assisted can use the principles of the invention.

In another embodiment of the invention particularly adapted for retrofit uses of the invention, a rectangular cross-section spring steel ribbon is used in the three element driver to drive fasteners that have a non-rectangular head shape; for example, a circular head. The rectangular ribbon moves in a rectangular passage, part of which is the arc section 88 and part of which is the upper end of the passage section 18. The impact segment has a cylindrical tip moving in a cylindrical passage section, being a lower part of the linear passage section 18. Both the impact segment and the passage section 18 have a cross-sectional transition from rectangular to circular. The transitions are dimensioned so that any point on the passage transition accommodates the cross-sectional span of any point on the driver transition that reaches or passes that point. Transition lengths are made small in order to keep the firing transit length small and also to limit the length of that part of the impact segment not closely confined by walls of the passage section 18. In a further embodiment of the invention, other mismatched cross-sections can be adopted: for example, a circular cross-section flexible segment to a rectangular cross-section impact segment.

Referring to FIGS. 24A to 24C, in a further embodiment of the invention adapted for driving either of two different fastener head shapes, the passage section 18 has a compound cross-section. In one example for driving both rectangular head staples and circular head nails, the compound cross-section is a superimposed circle and rectangle. If a rectangular cross-section impact segment is used, it is confined by ‘core’ wall parts defining the rectangular form within the compound cross-section. If a circular cross-section impact segment is used, it is confined by ‘core’ wall parts defining the circular form within the compound cross-section. Upstream, the impact segment is welded or otherwise fixed to a rectangular, circle or other cross-section ribbon provided that, in the course of the driver transit, any other part of the driver that enters the straight passage 18 ‘hides’ behind the impact segment 84.

Although embodiments of the invention have been described in the context of a board fastening tool, it will be appreciated that the tool can be used for other fastening functions which may not involve fastening board. In particular, the invention finds application where space is limited so that the strike or hammer direction cannot be the same as the impact or fastener direction. Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A fastening tool comprising
a tool body having a passage therein, the passage having a curvilinear passage section and a first linear passage section having a first linear direction, the curvilinear passage section contiguous at a leading end thereof with a trailing end of the first linear passage section,
an elongate driver mounted in and slidable along the passage, the driver having a linear impact segment and a flexible driver segment, the impact segment having a leading end for driving a fastener and a trailing end fixed to a leading end of the flexible driver segment,
the flexible driver segment constrained by an inside surface of the curvilinear passage section for curvilinear sliding therealong,
the linear impact segment and a leading part of the flexible driver segment constrained by an inside surface of the first linear passage section for linear sliding therealong.

2. The fastening tool as claimed in claim 1, wherein an extension from and integral with the leading end of the flexible driver segment is fixed to a trailing end part of the impact segment over a first fixing section, the first fixture section constrained by the inside surface of the first linear passage section for linear sliding therealong.

3. The fastening tool claimed in claim 1, wherein the leading end of the impact segment has one of a circular and a rectangular cross-section.

4. The fastening tool claimed in claim 2, wherein at the first fixture section, the extension is fixed to the trailing end part of the impact segment by a weld.

5. The fastening tool claimed in claim 4, wherein at the first fixture section, a rabbet is formed in the trailing end part of the impact segment and the extension is welded to the impact segment at the rabbet.

6. The fastening tool as claimed in claim 4, wherein the extension is thinner than the leading end of the flexible driver segment.

7. The fastening tool claimed in claim 5, wherein, at the first fixture section, an outer surface of the leading end part of the flexible driver segment and an outer surface of the impact segment adjacent the rabbet are co-planar.

8. The fastening tool claimed in claim 4, further comprising a groove formed in the trailing end part of the impact segment, the leading end part of the flexible driver segment being welded in the groove.

9. The fastening tool of claim 1, wherein the flexible driver segment is made of spring steel and the impact segment is made of hardened steel.

10. The fastening tool of claim 1, wherein the curvilinear passage section is one of round and rectangular in cross-section.

11. The fastening tool of claim 1, wherein the curvilinear passage section has a width varying along at least a part of its length in a plane normal to the curve of the curvilinear passage section.

12. The fastening tool claimed in claim 1, wherein the leading end part of the flexible driver segment is capped and the cap is fixed to the impact segment.

13. The fastening tool claimed in claim 1, wherein the first linear passage section has an inside surface portion at least partially defining a passage core, and the linear impact segment and the leading part of the flexible segment have an outside surface portion at least partially defining a driver core, the cross-section boundary of the driver core marginally smaller than the cross-section boundary of the passage core enable closely confined, non-binding linear sliding of the of the driver core along the passage core.

14. The fastening tool as claimed in claim 13, wherein the driver core has an outwardly radially extending projection received in a groove extending radially outwardly from the passage core into the tool body to provide sliding tracking of the driver in the passage.

15. The fastener tool of claim 1 for use in driving either of a fastener with a head having a first cross-sectional shape and a fastener having a head having a second cross-sectional shape wherein a tip of the impact segment and the first linear passage section have matching cross-sectional shapes that combine the first and second cross-sectional shapes.

16. The fastening tool claimed in claim 1, further comprising the curvilinear passage section being contiguous at its other end thereof with a second linear passage section extending in a second linear direction different from the first linear direction, and the driver having a linear hammer segment constrained by an inside surface of the second linear passage section for sliding therealong in the second linear direction, a trailing end of the flexible driver segment being fixed to a leading end part of the hammer segment.

17. The fastening tool of claim 16, further comprising a wall on the outside of the curvilinear passage section, the wall at respective ends thereof being generally tangential to the first and second linear directions.

18. The fastening tool of claim 16, wherein, with the fastening tool in an operational position, the first linear passage section is inclined at an angle between 30 and 60 degrees to the horizontal and the second linear passage section extends generally vertically.

19. The fastening tool of claim 16, wherein the driver is drivable in response to a downward blow applied to the hammer segment to drive a fastener from a stored position in the tool body to a fastening position outside of the tool body.

20. The fastening tool of claim 16, wherein the flexible driver segment has a length between the fixture thereof with the impact segment and the fixture thereof with the hammer segment that is longer than the aggregate of the length of the curvilinear passage section combined with a total longitudinal movement of the driver from a pre-impact position to a fastener driven position.
